(19) United States
(12) Patent Application Publication
(10) Pub. No.: US 2007/0077264 A1
(43) Pub. Date: Apr. 5, 2007

(54) PACKAGING FOR CHEMICAL MOTH AND INSECT REPELLENT PRODUCTS

(76) Inventor: Jonathan A. Mayer, Miami Beach, FL (US)

Correspondence Address: PAUL D. BIANCO: FLEIT, KAIN, GIBBONS,;GUTMAN, BONGINI, & BIANCO P.L., 21355 EAST DIXIE HIGHWAY, SUITE 115, MIAMI, FL, 33180, US

(21) Appl. No.: 11/536,936

(22) Filed: Sep. 29, 2006

Related U.S. Application Data
(60) Provisional application No. 60/722,823, filed on Sep. 30, 2005.
(60) Provisional application No. 60/736,113, filed on Nov. 10, 2005.

(51) Int. Cl. A01N 25/34

(52) U.S. Cl. 424/412

(57) ABSTRACT

A packaging system for repeatably storing chemical moth and insect repellent products that hinders oxygen and ultraviolet lighting from penetrating to prevent sublimation of the product prior to purchase. A user can store unused products after initial use and reopen the package at a later time to minimize the unused product's exposure to oxygen. Such storage prevents color and physical degradation of the product and adverse interaction of the product with ink used on the packaging material. Also provided is a method for using naphthalene, para-dichlorobenzene, camphor as an outdoor rodent, pest, moth, and insect repellent. The outdoor product can be scented and can be in various shapes or chemical forms, such as crystals.

### CROSS-REFERENCE TO RELATED APPLICATIONS

This Application claims the benefit under 35 U.S.C. §119(e) of: U.S. Provisional Patent Application No. 60/722,823 having a filing date of Sep. 30, 2005 and entitled PACKAGING FOR CHEMICAL MOTH AND INSECT REPELLENT PRODUCTS AND METHOD FOR PACKAGING THE PRODUCTS; and U.S. Provisional Patent Application No. 60/736,113 having a filing date of Nov. 10, 2005 and entitled PACKAGING FOR CHEMICAL MOTH AND INSECT REPELLENT PRODUCTS, METHOD FOR PACKAGING THE PRODUCTS, AND METHOD FOR USING NAPTHALENE, PARADICHLOROBENZE, AND CAMPHOR AS AN OUTDOOR RODENT, PET, MOTH, AND INSECT REPELLENT. The contents of each of the above-identified applications are herein incorporated by reference in their entirety.

### FIELD OF THE INVENTION

The present invention relates to packaging, and, in particular, to packaging for products containing naphthalene, para-dichlorobenzene, camphor and other chemical moth and insect repellent products that sublimate during usage and methods for packaging such products.

### BACKGROUND OF THE INVENTION

As used herein, a moth or insect repellent product (“Product”) is any product that contains naphthalene, para-dichlorobenzene, camphor, and related active and/or inactive ingredients, some of which are approved by the U.S. Environmental Protection Agency (EPA), for the purpose of repelling and/or killing such insects inside or outside the home. Presently, the EPA has approved naphthalene and para-dichlorobenzene for repelling moths indoors (use of these products can be made for storing clothing).

Products made of naphthalene, para-dichlorobenze, and camphor are sensitive to oxygen and will degrade over time (“sublimate”) when exposed to such. This degradation includes chemical discoloration, loss of shape of product, and, in some circumstances, complete absorption and loss of product. This is especially true when the products are placed outdoors as a result of the relatively more severe environmental characteristics, including extreme temperature, rain, wind, sleet, snow, and humidity, to name a few.

The products are conventionally sold in metal cans or in paperboard folding cartons that may have a transparent window. Typically, these containers are not gas-tight. Even if these containers include an inner bag holding the moth balls, the bag does not prevent exposure to oxygen after being opened. Further, the bag does not protect the moth balls from ultraviolet radiation.

The packaging for the products contains no protective barrier or oxygen absorber that prevents transmission of oxygen into the inner package containing the repellent. Contact between the product and oxygen causes the chemical product to prematurely sublimate, which erodes the life and strength of the product before it is even opened. Once opened, current packaging cannot reseal to prevent oxygen from further degrading unused product or to prevent further erosion of the product by exposure to ultraviolet radiation. Given that the smallest available container is 4 to 5 times larger than the typical recommended quantity of product per use, current product packaging allows the sublimating product to penetrate into the environment, which causes significant degradation and loss of product, not to mention unintentional release of a possibly undesirable odor.

Additionally, the sublimation of the chemical on a partial or complete basis will interfere with the ink printed on the consumer package, causing an unattractive bleeding through the package. Furthermore, it is known that naphthalene, para-dichlorobenzene, camphor and other chemical products adversely interact with oil-based ink conventionally used on paperboard folding cartons. Thus, the printing on such packaging becomes blurred over time as a result of this interaction.

In view of the foregoing, there exists a need for improved packaging for moth balls and other chemical moth and insect repellent products.

### SUMMARY OF THE INVENTION

The present invention provides a protective packaging for products containing naphthalene, para-dichlorobenzene, camphor and other chemical moth and insect repellent products that sublimate during usage. Specifically, the protective packaging provides a protective barrier, substantially preventing the migration of oxygen through the packaging material.

Additionally, the protective packaging can be resealable, having an opening which can be opened and resealed. The resealing mechanism provides a gas-tight seal, preventing the migration of oxygen into the packaging. In this manner, the unused products can be stored after the initial use and opening of the package, minimizing the unused product's exposure to oxygen and degradation.

The packaging material can further provide protection from ultraviolet radiation, having an opacity which inhibits the transmission of the ultraviolet radiation through the packaging material. Alternatively, the material of the packaging can have an inherent ultraviolet reflective properties or a coating. In such a case, it may not be necessary to make the packaging opaque.

In an embodiment, the present invention provides a packaging system for a chemical repellent. The packaging system includes a hollow bag member having a wall member and a open end defining an interior space, wherein the wall member is made of an impermeable material. A resealable closure mechanism is attached to the wall member of the hollow bag member in the open end. The resealable closure mechanism is positionable from an open position to a closed position, wherein in the closed position the open end is sealed in a gas-tight seal. A repellant is positioned in the interior space of the hollow bag member, wherein the repellant sublimates in air. The gas-tight seal of the resealable closure mechanism prevents exposure of the repellant to air, substantially preventing sublimation of the repellant.

The invention is primarily illustrated and described herein as embodied in packaging for products containing naphthalene, para-dichlorobenzene, camphor and other chemical moth and insect repellent products that sublimate during usage, a method for packaging such products, and a method for using naphthalene, para-dichlorobenzene, camphor as an outdoor rodent, pest, moth, and insect repellent. It is, nevertheless, not intended to be limited to the details shown because various modifications and structural changes may be made therein without departing from the spirit of the invention and within the scope and range of equivalents of the claims. For example, the present invention can be used with any material that sublimates or otherwise degrades.

The construction and method of operation of the invention, however, together with additional objects and advantages thereof, will be best understood from the following description of specific embodiments when read in connection with the accompanying drawings.

### BRIEF DESCRIPTION OF THE DRAWINGS

A more complete understanding of the present invention, and the attendant advantages and features thereof will be more readily understood by reference to the following detailed description when considered in conjunction with the accompanying drawings wherein:

FIG. 1 depicts a packaging system of the present invention;

FIG. 2 is a cross-sectional view of the packaging system of FIG. 1;

FIG. 3 is a partial cross-sectional view of a two-ply wall of the packaging system of FIG. 1;

FIG. 4 is a partial cross-sectional view of a three-ply wall of the packaging system of FIG. 1;

FIG. 5 depicts the packaging system of the present invention including a sealing mechanism;

FIG. 6 depicts a partial cross-sectional view of one embodiment of a sealing mechanism;

FIG. 7 depicts a partial cross-sectional view of another sealing mechanism;

FIG. 8 is a diagrammatic illustration of an exemplary embodiment of the packaging according to the invention;

FIG. 9 is a diagrammatic illustration of an exemplary embodiment of an evacuation device according to the invention; and

FIG. 10 is a fragmentary diagrammatic illustration of a portion of the packaging of FIG. 1 with another exemplary embodiment of the evacuation device according to the invention.

### DETAILED DESCRIPTION OF THE INVENTION

The present invention provides a chemical moth and insect repellent (“repellent”) which includes naphthalene, para-dichlorobenzene, camphor, and/or other chemicals and packaging system therefore. In addition to acting as a moth and insect repellent, such chemicals can also be used as a repellent for rodents and pests, both in indoor and outdoor uses.

As used herein, Naphthalene is a crystalline, aromatic, white, solid hydrocarbon, best known as the primary ingredient of moth balls. Its molecules consist of two fused benzene rings. When exposed to air, naphthalene slowly sublimes from a solid to a vapor. It is the vapor that acts as an insect repellant.

Para-dichlorobenzene (1,4-dichlorobenzene or p-DCB) is a white solid with a strong, pungent odor. It is an aromatic chemical compound having the chemical formula C₆H₄Cl₂. It consists of two chlorine atoms substituted onto a benzene ring. When exposed to air, p-DCB slowly sublimes from a solid to a vapor. It is the vapor that acts as an insect killer.

Camphor is a white transparent waxy crystalline solid with a strong penetrating pungent aromatic odor. It is a terpenoid with the chemical formula C₁₀H₁₆O. Camphor crystals when exposed to air, sublime from a solid to a vapor which acts as an insect killer.

The above chemicals can be used individually or in combinations to form the repellant, being provided in a variety of consistencies, shapes and sizes, which can be used to control the rate of sublimation. For example, the chemicals can be provided in a powder or crystalline form. Alternatively, the chemical can be provided in a substantially spherical form, i.e., moth balls, having a diameters ranging from 0.5 inches to 1 inch. It is contemplated that the chemical spheres can have larger or smaller diameters as desired.

From a strictly geometric point of view, a sphere has the greatest surface area, allowing for greater exposure to the environment and, thereby, increased degradation of the product. However, it has been unexpectedly discovered that moth or insect repellent products having spherical shapes that are significantly larger than conventionally manufactured spheres (which measure approximately 2.22 cm (⅞ inches) in diameter) actually sublimate at a slower rate, which increases their effectiveness and life span. As such, larger diameter spheres are especially suitable for outdoor use, where there repellent is exposed to a more extreme environment.

In an embodiment, the outdoor moth or insect repellent product made in a spherical or round shape is twice the circumference of conventional indoor moth balls to effectively slow down the sublimation process and extend the life of the product.

Alternatively, to minimize degradation, the repellent uses the chemicals in their crystalline or powder form. Such crystals and powders are able to fit into small crevices in the lawn and garden area, for example, and, as such, will last longer than conventional moth balls having more surface area to be exposed to the elements outdoors. The crystal shape allows the user to specifically place the product in holes, ant hills, and hard to reach areas where insects, roaches and some rodents reside. The net effect is a more pin-point placement of such items causing increased effectiveness of the product. Additionally, unlike chemical moth balls of any size, crystallized outdoor products are easily carried into ant hills by the ants and other areas where insects nest, effectively reaching the source of many insect and animal breeding areas before their sublimation.

As previously discussed, the repellent is provided in a solid form, which when exposed to air sublimates to a vapor, which acts as repellant. In the vapor form, the repellant can have a strong, unpleasant odor. As such, it is contemplated that an aromatic can be added to the repellant, where the aromatic has a substantially pleasant odor which can mask the odor of the repellant.

In an embodiment, the aromatic can have properties similar to that of the repellant, where the aromatic acts as a repellent, and may enhance the effectiveness of the repellant. For example, the aromatic can be cedar, citronella, pepper, frankincense, among others.

Alternatively, the aromatic can be a scent which masks the odor the repellant. Such scent can be provided in a variety of fragrances, for example, pine, lavender, lemon, potpourri, etc.

As previously discussed, the repellant of the present invention sublimates when exposed to air, such that when in use the repellent changes from a solid to a vapor. However, when not in use, it is desirable to prevent sublimation, allowing the repellant to be stored for later use. As such, another aspect of the present invention is a packaging system which substantially prevents exposure of the repellant to air, moisture, etc.

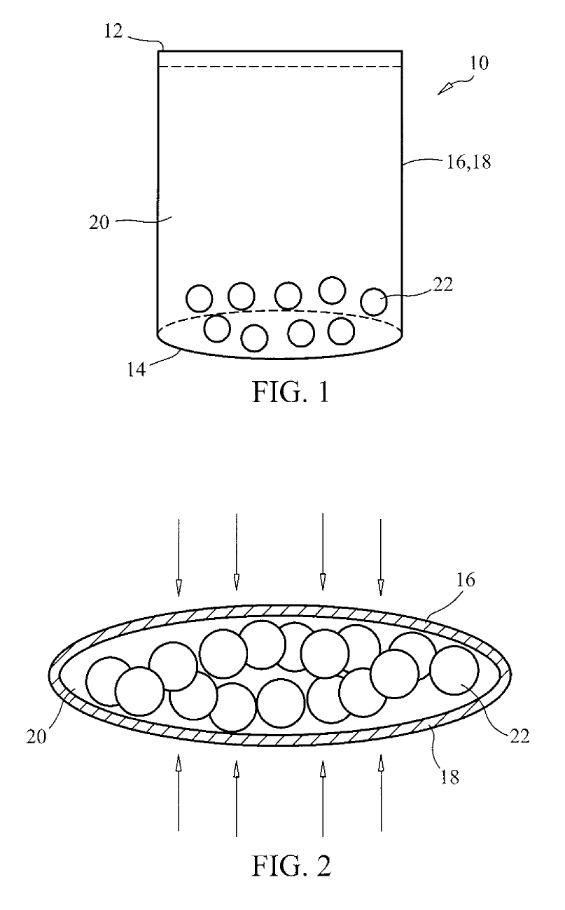

Referring now to the drawing figures in which like reference designators refer to like elements, there is shown in FIGS. 1 and 2 a packaging system 10 of the present invention. The packaging system 10 is provided in a pouch form having first and second ends 12 and 14, and two walls 16 and 18 defining an interior space 20 therein. The repellant 22 is positioned in the interior space 20, being sealed within the packaging system 10. The first and second ends 12 and 14 are provided in a closed form, preventing propagation of air there through.

In a method of manufacture, the walls 16 and 18 can be positioned on opposite sides of the repellant 22, where the peripheries of the walls 16 and 18 are sealed together forming the pouch containing the repellant 22. The peripheries of the walls 16 and 18 can be sealed using known sealing techniques, such as heat sealing, gluing, etc.

Alternatively, the packaging system 10 can initially be provided in a bag form in which the first end 12 is open, allowing the repellent 22 to be deposited in the interior space 20. Once filled, the first end 12 is sealed preventing entry of air into the interior space 20 there through. The first end 12 can be sealed using known sealing techniques, such as heat sealing and/or gluing.

The walls 14 and 16 are made of a substantially impermeable material which prevents the propagation of air into the interior space 20. In this manner, the repellant 22 is maintained in a sealed environment within the packaging material, preventing sublimation of the repellant 22. It is also envisioned that the repellant is vacuumed sealed.

In an embodiment the walls 16 and 18 are made of flexible polymeric or plastic materials. For example, the walls 16 and 18 can be made of polyethylene, polyethylene terephthalate, oriented polypropylene, and the like. Additionally, to prevent penetration of ultraviolet radiation, the walls 14 and 16 can be opaque or have a coating that reflects ultraviolet radiation. Alternatively, the material of the walls 16 and 18 can have inherent ultraviolet reflective properties.

The walls 16 and 18 can be formed using a plurality of layers, wherein each of the layers can be made from the same or different materials. Each of the layers can have the same or different thickness. The materials for each of the layers are selected to combine to form a flexible impermeable wall that substantially prevents the propagation of air there though.

In an embodiment, each of the material layers of the walls 16 and 18 can be made from a plastic material, such as, polyethylene, polyethylene terephthalate, oriented polypropylene, and the like, either as a whole in combinations thereof. The material layers can be bonded together using known bonding techniques, such as gluing and/or heat sealing. Additionally, the thickness of each layer can be selected, such that the thickness of each of the walls 16 and 18 is between about 0.05 mm and 15 mm.

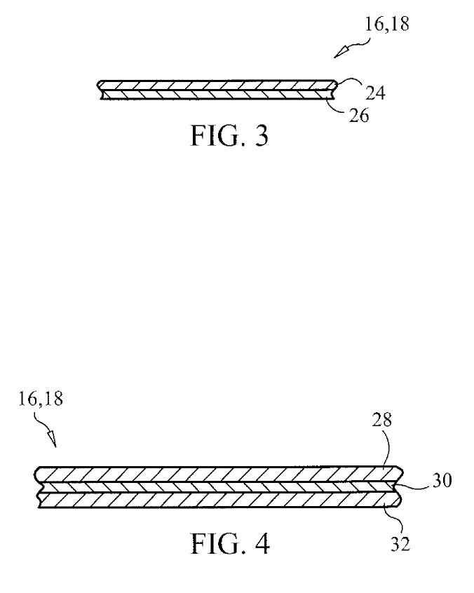

Referring to FIG. 3, the walls 16 and 18 are two-ply members, having an inner layer 24 and outer layer 26. Each of the material layers 24 and 26 can be made from a plastic material, such as, polyethylene, polyethylene terephthalate, oriented polypropylene, and the like. The layers 24 and 26 are combined such that each of the walls 16 and 18 has the thickness of 0.05 mm to 0.10 mm.

In an example, the inner layer 24 is made from polyethylene and the outer layer 26 is made from polyethylene terephthalate. The inner and outer layers are bonded together using known bonding techniques, such as gluing. The layers 24 and 26 are combined such that each of the walls 16 and 18 has the thickness of about 0.06 mm, where the inner layer 24 can have a thickness of about 0.045 mm and the outer layer 26 can have a thickness of about 0.015 mm.

Referring to FIG. 4, the walls 16 and 18 are three-ply members, having an inner layer 28, a middle layer 30, and outer layer 32. Each of the material layers 28, 30, and 32 can be made from a plastic material, such as, polyethylene, polyethylene terephthalate, oriented polypropylene, and the like. The layers 28, 30, and 32 are combined together such that each of the walls 16 and 18 has the thickness of 0.10 mm to 0.15 mm.

In an example, the inner layer 28 is made from polyethylene, the middle layer 30 is made from polyethylene terephthalate, and the outer layer 32 is made from oriented polypropylene. The inner, middle, and outer layers are bonded together using known bonding techniques, such as gluing. The layers 28, 30, and 32 are combined together such that each of the walls 16 and 18 has the thickness of about 0.12 mm. The inner layer 28 can have a thickness of about 0.07 mm, the middle layer 32 can have a thickness of about 0.015 mm, and the outer layer has a thickness of about 0.025 mm.

The oriented polypropylene of the outer layer 28 can be oriented to provide an inherent ultraviolet protection to the packaging system 10, whereby the orientation is selected to give an ultraviolet reflectivity to the outer layer 28 of the walls 16 and 18.

In the above embodiments, the packaging material 10 is provided to the consumer in a sealed condition, such that the sublimation of the repellant 22 is retarded, increasing the shelf life of the repellant 22. It is also contemplated that the packaging system 10 can include a resealing mechanism, wherein after opening and partial removal of the repellant 22 therein, the packaging system 10 can be resealed to protect the remaining repellent 22. The sealing mechanism provides a gas-tight seal to the open portion of the packaging system 10, preventing entry of air therein.

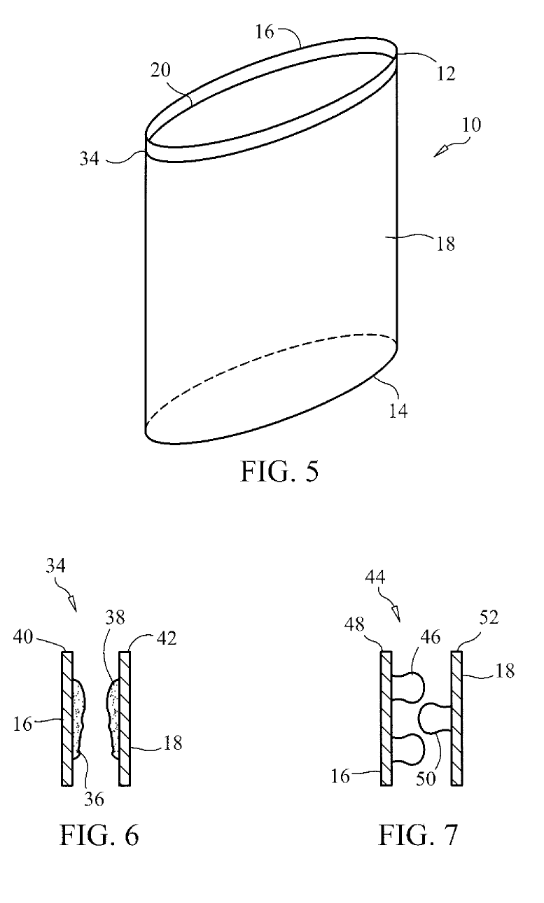

Referring to FIG. 5, the packaging system 10 is shown having an open first end 12 which can be opened by cutting, tearing, and the like. A sealing mechanism 34 is provided, proximal to the open first end 12. The sealing mechanism 34 seals the open first end 12 when the ends of wall 16 and 18 are compressed together.

Referring to FIG. 6, one embodiment of the sealing mechanism 34 includes adhesive coatings 36 and 38 provided on the walls 16 and 18, proximal to the first end 12. The adhesive coatings 36 and 38 are bonded to the inner surfaces 40 and 42 of the walls 16 and 18, such that when the walls 16 and 18 are compressed together the adhesive coatings 36 and 38 bond together, sealing the open first end 12. The adhesive coatings 36 and 38 are such that the walls 16 and 18 can be separated, separating the adhesive coatings 36 and 38 to open the first end 12 and thereafter compressed together to reseal the open first end 12. It is contemplated that this opening and resealing can be accomplished a plurality of times, until all of the repellant 22 contents have been used. It is further contemplated that one of the adhesive coatings 36 and 38 can be eliminated such that the remaining adhesive coating attaches directed to either wall 16 or wall 18.

Referring to FIG. 7, a different embodiment of the sealing mechanism 34 includes a tongue and groove sealing mechanism 44. In particular, a groove portion 46 is provided on an inner surface 48 of the wall 16 and a tongue portion 50 is provided on an inner surface 52 of wall 18 proximal to the first end 12. The walls 16 and 18 are compressed together such that the tongue portion 50 engages the groove portion 46, sealing the open first end 12. The sealing mechanism 44 is designed such that the walls 16 and 18 can be separated to open the first end 12 and thereafter compressed together to reseal the open first end 12, providing a gas-tight seal. It is contemplated that this opening and resealing can be accomplished a plurality of times, until all of the repellant 22 contents have been used.

In the above embodiment, a single tongue and groove sealing mechanism 44 is depicted. However, it is contemplated that multiple tongue and groove sealing mechanisms 44 can be utilized. The multiple sealing mechanisms 44 are positioned in the open first end 12 in a spaced apart parallel relationship. The use of multiple sealing mechanisms 44 is effective in increasing the efficiency of the gas-tight seal. In an exemplary embodiment, two tongue and groove sealing mechanisms 44 are provided in the open first end 12.

The present invention contemplates other sealing mechanisms. For example, reclosable fastener assemblies often include a plastic zipper and a slider. Typically, the plastic zippers include a pair of interlockable fastener elements, or profiles, that form a closure. As the slider moves across the profiles, the profiles are opened or closed. The profiles in plastic zippers can take on various configurations. The sliders for opening or closing the reclosable fasteners are generally shaped so that the slider straddles the profiles. The sliders often include a separating element that is inserted through the profiles in order to open the fastener. In other types of sliders, the separating element does not penetrate the profiles, but rather, slides above the profiles on a specially adapted track located above the profiles. The separating elements may have various shapes, such as a V-shaped separating element or a tapered separating element with a circular end.

In a laboratory investigation, the sublimation rate of unused repellant in a stored condition was determined for a prior art packaging and for a resealed three-ply packaging system 10 of the present invention.

The prior art packaging included a cardboard box container having an outer plastic wrapping. The top right side and two adjacent ends of the outer plastic wrapping were cut, allowing the top flap to be opened by breaking the glue seam and thereby exposing the repellent therein. The repellent was removed, weighed, and placed back into the prior art packaging. The top flap was lower back into place and the prior art packaging was positioned in a test environment. The initial weight of the repellant provided in the prior art packaging was 731.5 g.

The test packaging system 10 of the present invention includes three-ply walls 16 and 18 and two tongue and groove sealing mechanisms 44 provided at the first end 12. The three-ply walls 16 and 18 had an inner layer 28 made from polyethylene, a middle layer 30 made from polyethylene terephthalate, and an outer layer 32 made from oriented polypropylene. The inner layer had a thickness of approximately 0.07 mm, the middle layer had a thickness of approximately 0.015 mm, and the outer layer had a thickness of approximately 0.025 mm. The inner, middle, and outer layers were bonded together. The first end 12 of the test packaging system 10 was opened. The repellent was removed, weighed, and placed back into test packaging system 10. The first end of test packaging system 10 was resealed using the two tongue and groove sealing mechanisms 44 and the test packaging system 10 was positioned in a test environment. The initial weight of the repellant provided in the test packing system 10 was 694.7 g.

The prior art packaging and the test packaging system 10 were each placed in a test environment for a twelve-day test period. Each of the test environments included a sealed fifty-five gallon steel drum placed in an outdoor environment and exposed to direct sunlight. The interior temperature of the drum was monitored, recording cyclic temperature changes based on the ambient outdoor temperature, where temperature spikes of 50° C. were recorded.

As noted above, the weight of the repellant in the prior art packaging was 731.4 g. Upon completion of the test period, the weight of the repellant in the prior art packaging was 713.3 g., resulting in a percent loss of 2.47%. A projected percent weight loss for a twelve-month period is estimated at 59.39%.

In comparison, the initial weight of the repellant in the test packaging system 10 was 694.7 g. Upon completion of the test period, the weight of the repellant in the test packaging system 10 was 694.7 g, resulting in no observable loss. Based on the foregoing, the test packaging system 10 according to the present invention would result in a projected percent weight loss for a twelve-month period of less than 10% and more preferably less than 1.0%.

The results of the laboratory investigation demonstrate the benefits of packaging system 10 of the present invention. As repellent is frequently sold in quantities greater than required for use, the unused repellent is inevitably stored for later use. As demonstrated by the laboratory investigation, storage in prior art packaging results in significant loss of repellent due to sublimation. In contrast, storage in the packaging system 10 of the present invention results in negligile loss of repellant, estimated at less than 10% (and more preferably less than 1.0%) over month period.

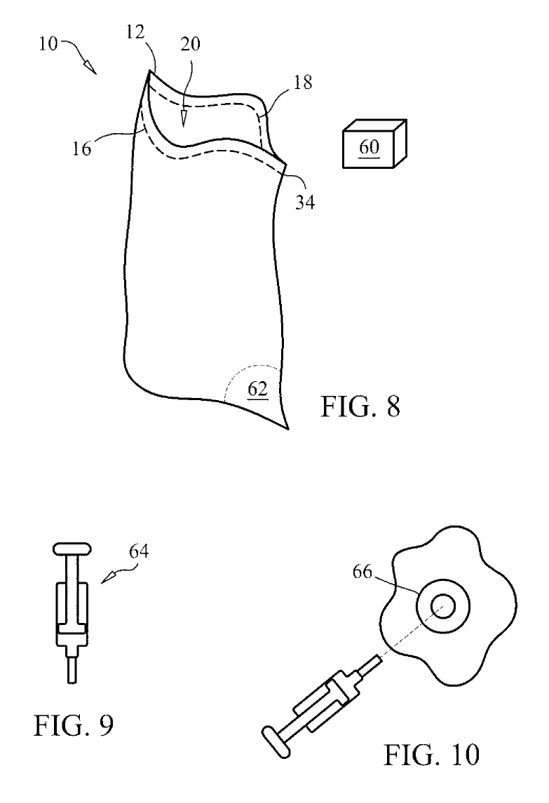

Referring now to FIG. 8, an oxygen limiting device 60, 62 is either separate from the packaging 10 (as in the case for device 62) and placed inside the packaging 10 or is part of the packaging 10 (as in the case for device 60). This device 60, 62 is contained within the packaging with the repellant 22 before the seat 34 is closed.

When the repellant 22 is inserted in the packaging 10 to the desired level of filling, it is desirable to evacuate the air present in the packaging 10. Therefore, preferably, the packaging 10 flexible so that it can be made to conform to the shape of the items therein and, thereby, minimize the amount of air therein.

To better conform the shape of the packaging 10 to the repellant 22 to be stored therein the packaging 10 is, in an alternative and/or additional exemplary embodiment, provided with an evacuation device 64. One exemplary embodiment of the evacuation device 64 is a siphon, which can be in the form of a syringe that is first located within the packaging 10. The packing 10 is then closed about the evacuation device 64 and the evacuation device 64 is cause to draw the air out from the interior 20 of the packaging 10.

Another exemplary embodiment of the evacuation device is a siphon 64, which can be in the form of a syringe or any other kind of vacuum generating device, such as a pump, that is not associated with the packaging 10. Instead, a sealing portal 66 is located at the packaging 10 and forms a gas-tight seal when the siphon 64 is not attached thereto but permits gas to be drawn out from the interior 20 of the packaging 10 when the siphon 64 is inserted into the portal 66.

A method for packaging a chemical insect and moth repellent 22 according to the invention includes providing a substantially gas-tight package having an interior for receiving the repellant 22 therein. In one exemplary embodiment, the package has walls that are opaque to prevent penetration of ultraviolet radiation or that have a coating that reflects ultraviolet radiation. Alternatively, the material of the packaging can have inherent ultraviolet reflective properties.

A device for removing or minimizing oxygen is associated with the interior of the packaging.

The package is then sealed with the repellant 22 and oxygen minimizing device therein. To further minimize oxygen in the package, an evacuation device can be fluidically connected to the interior of the package and air in the package can be removed therefrom. If the package is flexible, then evacuation of the air will cause the package to conform to the outer shape of the contents and minimize oxygen in the package.

After being sealed in the package, the life of the product can be extended virtually perpetually after initial use of the product. Anytime after sealing, the package can be reopened, a quantity of the repellant 22 can be removed for use, and the package can be resealed and reevacuated for further storage and preservation of the product.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A packaging system for a chemical repellent comprising:
a hollow bag member including a wall member and an open end defining an interior space, wherein the wall member is made of an impermeable material;
a resealable closure mechanism attached to the wall member of the hollow bag member in the open end, the resealable closure mechanism positionable from an open position to a closed position, wherein in the closed position the open end is sealed in a gas-tight seal; and
a repellant positioned in the interior space of the hollow bag member, wherein the repellant sublimates in air.

2. A packaging system as set forth in claim 1 wherein the wall member includes a plurality of layers.

3. A packaging system as set forth in claim 2, wherein each of the plurality of layers is made of a polymer selected from the group consisting of polyethylene, polyethylene terephthalate, and oriented polypropylene.

4. A packaging system as set forth in claim 3 wherein the wall member includes an inner layer and an outer layer.

5. A packaging system as set forth in claim 4 wherein the inner layer is made of polyethylene and the outer layer is made of polyethylene terephthalate.

6. A packaging system as set forth in claim 5,wherein the inner layers has a thickness of about 0.045 mm and the outer layer had a thickness of about 0.015 mm.

7. A packaging system as set forth in claim 3, wherein the wall member includes an inner layer, a middle layer, and an outer layer.

8. A packaging system as set forth in claim 7 wherein the inner layer is made of polyethylene, the middle layer is made of polyethylene terephthalate, and the outer layer is made of oriented polypropylene.

9. A packaging system as set forth in claim 8 wherein the inner layer has a thickness of about 0.07 mm, the middle layer has a thickness of about 0.015 mm, and the outer layer has a thickness of about 0.025 mm.

10. A packaging system as set forth in claim 8 wherein at least one of the layers is an ultraviolet protective layer.

11. A packaging system as set forth in claim 1 wherein the resealable closure mechanism is a tongue and groove closure mechanism.

13. A packaging system as set forth in claim 1 wherein the resealable closure mechanism is an adhesive type closure mechanism.

14. A packaging system as set forth in claim 1, wherein the repellent includes chemicals selected from the group consisting of naphthalene, para-dichlorobenzene, camphor, and combinations thereof.

15. A packaging system as set forth in claim 14, wherein the repellent further includes an aromatic.

16. A packaging system for a chemical repellent comprising:
a hollow bag member including a wall member and an open end defining an interior space, wherein the wall member includes a plurality of layers affixed together forming an impermeable barrier;
a tongue and groove resealable closure mechanism attached to the wall member of the hollow bag member in the open end, the tongue and groove resealable closure mechanism positionable from an open position to a closed position, wherein in the closed position the open end is sealed in a gas-tight seal; and
a repellant positioned in the interior space of the hollow bag member, wherein the repellant is naphthalene, para-dichlorobenzene, camphor, or combinations thereof.

17. A packaging system as set forth in claim 16 wherein the wall member includes a first layer made of polyethylene and a second layer made of polyethylene terephthalate.

18. A packaging system as set forth in claim 17 wherein the first layers has a thickness of about 0.045 mm and the second layer has a thickness of about 0.015 mm.

19. A packaging system as set forth in claim 17 wherein the wall member includes a third layer made of oriented polypropylene.

20. A packaging system as set forth in claim 19 wherein the first layers has a thickness of about 0.07 mm, the second layer has a thickness of about 0.01 mm, and the third layer has a thickness of about 0.025 mm.
